(19) United States
(12) Patent Application Publication
(10) Pub. No.: US 2021/0282609 A1
(43) Pub. Date: Sep. 16, 2021

(54) APPARATUS FOR REMOVING DEBRIS AND PARTICULATE MATTER FROM AUTOMOTIVE BODIES

(71) Applicant: Honda Motor Co., Ltd., Tokyo (JP)

(72) Inventors: Martin P. SCARPITTI, Dublin, OH (US); Christopher W. CRONAN, Dublin, OH (US); Richard W. GEARY, Columbus, OH (US)

(21) Appl. No.: 16/816,789

(22) Filed: Mar. 12, 2020

(51) Int. Cl. A47L 9/02; B60S 3/00

(52) U.S. Cl. CPC A47L 9/02; B60S 3/00

(57) ABSTRACT

A vacuum attachment attached to a distal end of a vacuum hose of a vacuum cleaning apparatus in a manufacturing environment includes a deck that extends outward from a central opening. The deck includes a top surface, a bottom surface, and a neck extending from the top surface about the central opening, the distal end of the vacuum hose being attached to the neck. The bottom surface engages with a work piece from which debris and particulate matter is to be removed that features a plurality of spacing elements extending from the bottom surface of the deck and a stopper disposed in the central opening and neck of the deck. The stopper include a base portion received in the central opening of the deck, and an opening through which debris and particulate matter is capable of being received into the vacuum hose.

### TECHNICAL FIELD

The embodiments described herein relate to attachments for a vacuum hose in general, and more specifically to a vacuum attachment in a welding and manufacturing environment.

### BACKGROUND

In a manufacturing environment, the process of welding leaves welding debris on work pieces that may in turn affect the quality of further processes, such as painting or the application of specialized coatings. Welding debris may include weld spatter, weld balls, debark granules, polyphenylene (PPE) fibers, metallic and non-metallic dust and chips, and other types of debris ranging in size from 35 micrometers to 5 mm in size. The welding debris must be removed, and there is established a need to remove the welding debris in a controlled manner that prevents these small particles from being transferred to other parts of the work piece in the cleaning cycle.

In addition to welding debris, there is also established a need to remove particulate matter and other types of debris from work pieces in other locations of the manufacturing environment.

### APPLICATION SUMMARY

The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes, and may not have been selected to delineate or circumscribe the inventive subject matter.

According to one aspect, a vacuum cleaning apparatus for removing debris from a work piece includes a vacuum source, a vacuum hose attached to the vacuum source, a vacuum receptacle for receiving debris through the vacuum hose, and a vacuum attachment attached to a distal end of the vacuum hose for engaging the work piece. The vacuum attachment includes a deck that extends radially outward from a central opening, the deck having a top surface, a bottom surface, and a neck extending from the top surface about the central opening, the distal end of the vacuum hose being attached to the neck, and the bottom surface engaging with the work piece from which debris is to be removed, and a stopper disposed in the central opening and neck of the deck.

According to another aspect, a vacuum attachment attached to a distal end of a vacuum hose of a vacuum cleaning apparatus includes a deck that extends radially outward from a central opening, the deck having a top surface, a bottom surface, and a neck extending from the top surface about the central opening, the distal end of the vacuum hose being attached to the neck, and the bottom surface engaging with a work piece from which debris is to be removed, and a stopper disposed in the central opening and neck of the deck.

According to yet another aspect, a vacuum attachment attached to a distal end of a vacuum hose of a vacuum cleaning apparatus includes a deck that extends radially outward from a central opening, the deck having a top surface, a bottom surface, and a neck extending from the top surface about the central opening, the distal end of the vacuum hose being attached to the neck, and the bottom surface engaging with a work piece from which debris is to be removed, a plurality of spacing elements extending from the bottom surface of the deck, and a stopper disposed in the central opening and neck of the deck. The stopper include a base portion received in the central opening of the deck, and an opening through which debris is capable of being received into the vacuum hose.

### BRIEF DESCRIPTION OF THE DRAWINGS

FIG. 1 is a schematic view of a vacuum cleaning apparatus for removing debris from a work piece in a manufacturing environment.

FIG. 2 is a lower perspective view of one embodiment of a vacuum attachment.

FIG. 3 is a lower perspective view of another embodiment of a vacuum attachment.

FIG. 4 is a lower perspective view of yet another embodiment of a vacuum attachment.

FIG. 5 is a lower perspective view of still yet another embodiment of a vacuum attachment.

FIG. 6 is a cross-sectional view of the vacuum attachment of FIG. 2 taken online Section A-A.

FIGS. 7A-7E are lower perspective views of embodiments of a stopper with an annular openings.

FIGS. 8A-8B are lower perspective views of embodiments of a stopper with single-hole openings.

FIGS. 9A-9B are lower perspective views of embodiments of a stopper with a plurality of openings.

FIG. 10 is an alternate embodiment of a spacing element that may be attached to the vacuum attachment.

FIG. 11 is another alternate embodiment of a spacing element that may be attached to the vacuum attachment.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

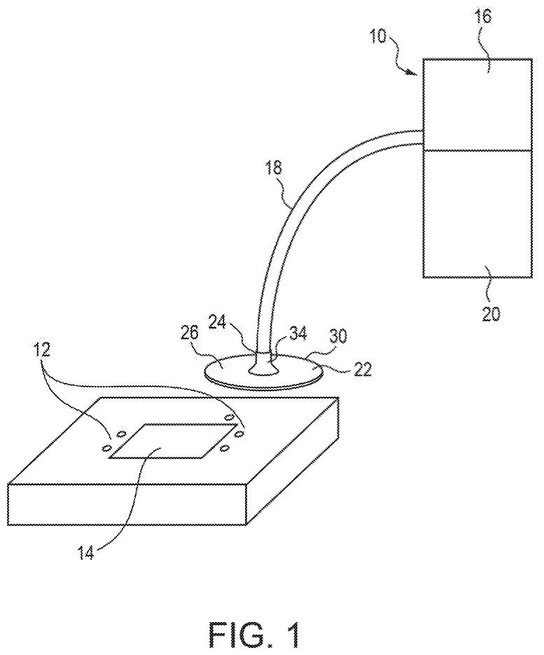

FIG. 1 is a schematic view of a vacuum cleaning apparatus 10 for removing debris 12, and any other particulate matter, from a work piece 14 in a manufacturing environment. A typical vacuum cleaning apparatus 10 includes a vacuum source 16, a vacuum hose 18 attached to the vacuum source 16, and a vacuum receptacle 20 for receiving the debris 12 through the vacuum hose 18. The vacuum cleaning apparatus 10 further includes a vacuum attachment 22 attached to a distal end 24 of the vacuum hose 18 for engaging the work piece 14. The debris 12 may be weld spatter, weld balls, debark granules, PPE fibers, metallic and non-metallic dust and chips, and other types of debris that must be removed to prevent it from affecting paint quality.

The work piece 14 may be any welded part produced or assembled in a manufacturing environment including, but not limited to, an automotive body or part, a replacement part, or any other welded part.

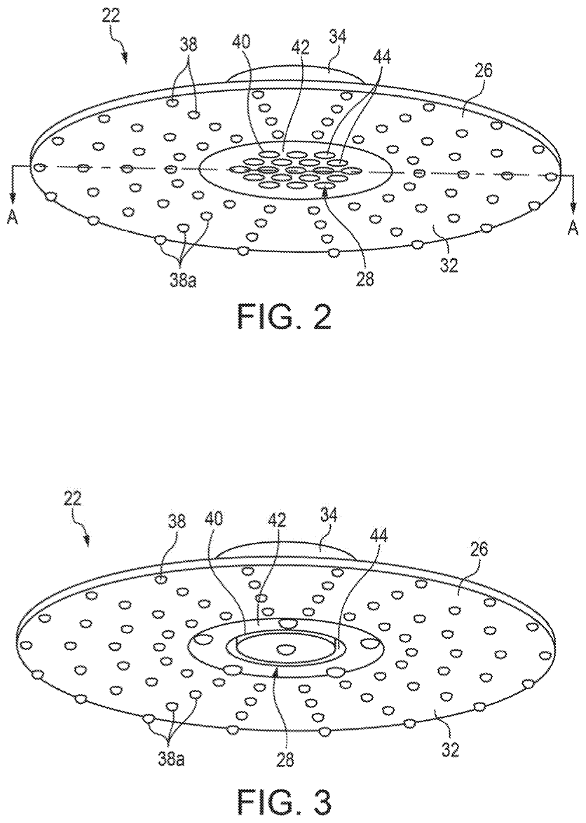

FIGS. 2-9B illustrate embodiments of the vacuum attachment 22 in greater detail. The vacuum attachment 22 includes a deck 26 that is relatively flat. The deck 26 may be circular in shape that extends radially outward from a central opening 28. However, the deck 26 may be constructed in additional shapes for specific applications in the manufacturing environment. For example, FIG. 5 illustrates a vacuum attachment with a square-shaped deck 26, which permits the vacuum attachment 22 to have access to corners of the work piece 14. The deck 26 includes a top surface 30 and a bottom surface 32.

A neck 34 extends from the top surface 30 of the deck 26 about the central opening 28, and the distal end 24 of the vacuum hose 18 is received in the neck 34 and is the point of attachment to the vacuum cleaning apparatus 10. The neck 34 may be a solid cylindrical piece as illustrated, or alternatively, may be constructed of a flexible bellows or rotatable about a plurality of bearings.

The bottom surface 32 engages with the work piece 14 from which debris 12 is to be removed. The deck 26 is constructed from a flexible material, such as plastic, fabric, fiberglass, rubber, or a composite made of a plurality of materials. The flexibility of the deck 26 allows for a consistent gap to be maintained over contoured surfaces of the work piece 14. The flexible material of the deck 26 may be selected based upon a number of factors including, but not limited to, maximum bend angle, minimum bend radius, bending fatigue durability, chemical resistance, impact resistance, tear resistance, laceration resistance, abrasion resistance, temperature indifference, elasticity, manufacturability and cost, and service considerations.

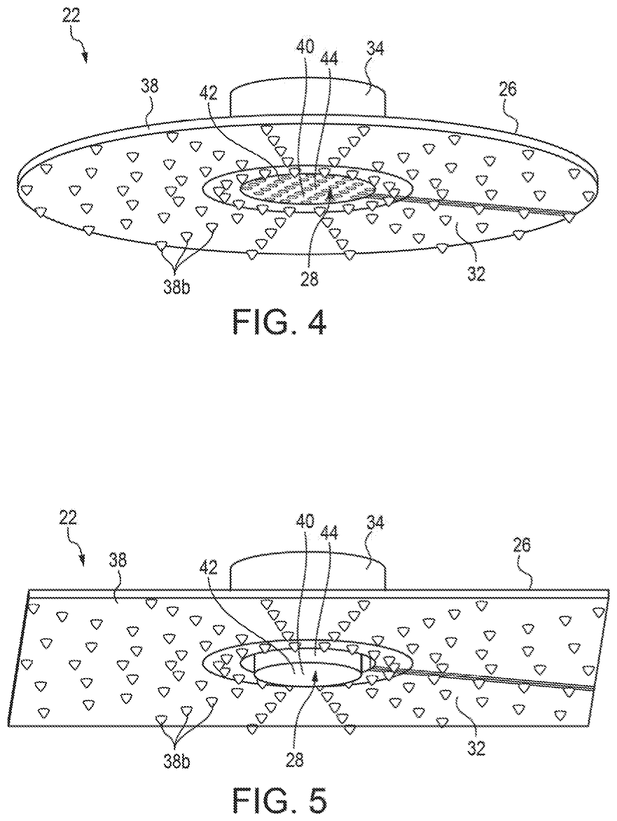

The vacuum attachment 22 at the end of a vacuum hose 18, which includes the central opening 28 in which a stopper 40 is disposed at the center of a flexible deck 26, is suspended over debris 12 and dirty surfaces by a plurality of spacing elements 38. These spacing elements 38 serve to maintain a minimally small air gap between the deck 26 and the work piece 14 in order to maximize the air flow velocity around the target particles of debris 12. The spacing elements 38 extend from the bottom surface 32 of the deck 26, and may be approximately 5.0 mm in height, although they may extend up to 20 mm in certain applications related to capturing light debris. The height of the spacers may also be adjustable according to the need of the specific application. The spacing elements 38 may be generally rounded spacing elements 38a, essentially in the shape of a semi-circular sphere as illustrated in FIGS. 2-3. Alternatively, the spacing elements 38 may be conically shaped spacing elements 38b as illustrated in FIGS. 4-5.

In alternate embodiments, the spacing elements 38 may be constructed of assembled materials. For example, as illustrated in FIG. 10, spacing elements 38c may be constructed of nylon or nylon-like brushes. As illustrated in FIG. 11, spacing elements 38d may be constructed of a ball transfer integrated into a set screw. The spacing elements 38 may integrally formed in the bottom surface of the 32 of the deck 26, or the spacing elements 38 may be removable and replaceable. The spacing elements 38 for a particular application may be selected based on a number of factors including, but not limited to, abrasion resistance, resistance to breakage, risk of damage to the work piece 14, chemical resistance, cost, ease of replacement, availability, tunability or adjustability, durability, and other factors known to those skilled in the art. Other shapes or elements may be used for the spacing elements that are known to those skilled in the art. The size of the spacing elements 38 may be selected based on the size of the debris or particulate matter to be collected by the vacuum cleaning apparatus 10.

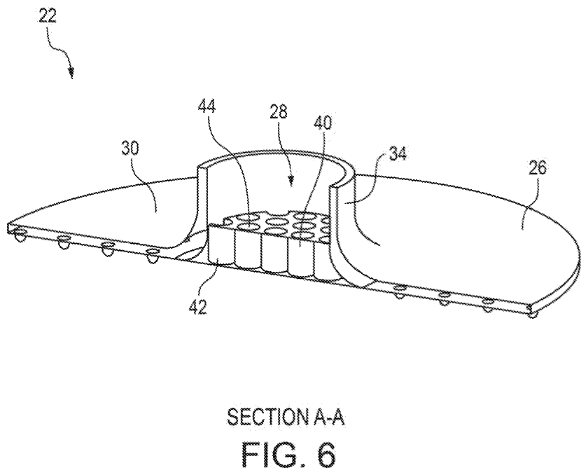

The vacuum attachment 22 further includes a stopper 40 located in the central opening 28, illustrated in FIG. 6, which is a cross-sectional view of taken along line A-A of FIG. 2. The stopper 40 acts to reduce the radial velocity of particles of the debris 12 to zero directly below the central opening 28. Air flows between the deck 26 and the work piece 14 through the central opening 28 and through the neck 34 connecting the deck 26 to the vacuum hose 18. The stopper 40 includes a base portion 42 received in the central opening 28 of the deck 26. The base portion 42 may be held by a friction fit, an interference fit, or through the use of appropriate fasteners or adhesives. The stopper 40 further includes an opening 44 through which debris 12 is capable of being received into the vacuum hose 18.

The stopper 40 may be constructed as a separate part from the deck 26 and neck 34 and attached permanently or removably by adhesives, fasteners, and the like. Alternatively, the stopper 40 may be integrally formed or co-molded with the deck 26 and neck 34 of the vacuum attachment 22.

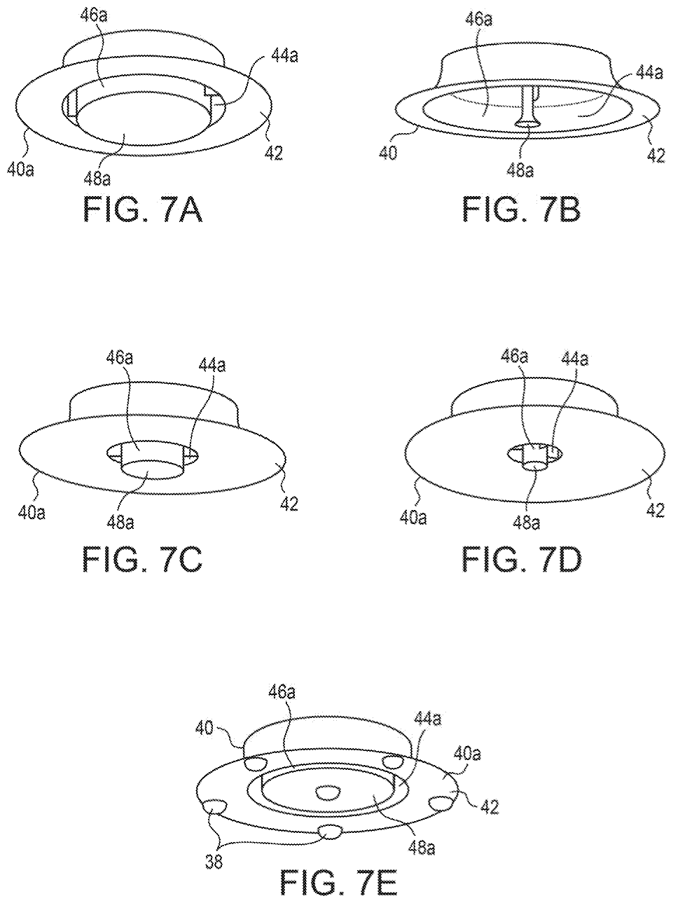

The stopper 40 may be configured according to a plurality of embodiments. The first primary embodiment of the stopper 40a is illustrated in FIGS. 7A-7E, as well as FIGS. 3 and 5, in which the opening 44a is annular, composed essentially of an open ring portion 46a surrounding a solid center 48a portion formed in the base 42. FIGS. 7A-7E illustrate open ring portions 46a and solid center portions 48a of varying sizes, any of which may selected based on performance and the size of the debris 12 to be collected. FIG. 7E further illustrates that any embodiment of the stopper 40 may include spacing elements 38 as described above.

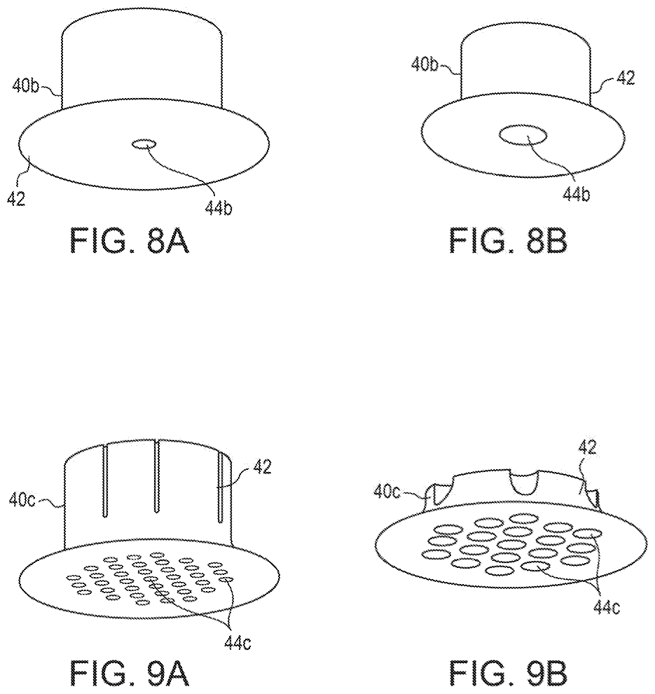

The second primary embodiment of the stopper 40b is illustrated in FIGS. 8A-8B in which the opening 44b is a single hole formed in the base 42. FIGS. 8A-8B illustrate openings 44b of varying sizes, either of which may also be selected based on performance and the size of the debris 12 to be collected.

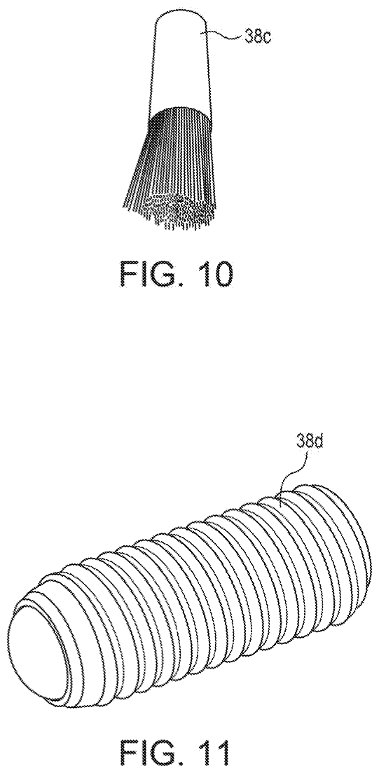

The third primary embodiment of the stopper 40c is illustrated in FIGS. 9A-9B, as well as FIGS. 2 and 4, in which the opening 44c includes a plurality of holes formed in the base 42. FIGS. 9A-9B illustrate a plurality holes of the opening 44c of varying sizes, any of which may also be selected based on performance and the size of the debris 12 to be collected.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments, which is set forth in the claims.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

What is claimed is:

1. A vacuum cleaning apparatus for removing debris from a work piece, comprising:
a vacuum source;
a vacuum hose attached to the vacuum source;
a vacuum receptacle for receiving debris through the vacuum hose; and
a vacuum attachment attached to a distal end of the vacuum hose for engaging the work piece, comprising:
a deck that extends outward from a central opening, the deck having a top surface, a bottom surface, and a neck extending from the top surface about the central opening, the distal end of the vacuum hose being attached to the neck, and the bottom surface engaging with the work piece from which debris is to be removed; and
a stopper disposed in the central opening and neck of the deck.

2. The vacuum cleaning apparatus of claim 1 wherein the deck further comprises:
a plurality of spacing elements extending from the bottom surface of the deck.

3. The vacuum cleaning apparatus of claim 2 wherein the plurality of spacing elements are substantially round in shape.

4. The vacuum cleaning apparatus of claim 2 wherein the plurality of spacing elements are substantially conical in shape.

5. The vacuum cleaning apparatus of claim 2 wherein the plurality of spacing elements are radially aligned along a plurality of radii extending along the bottom surface from the central opening of the deck to an outer edge of the deck.

6. The vacuum cleaning apparatus of the claim 1 wherein the deck is comprised of a flexible material.

7. The vacuum cleaning apparatus of claim 1 wherein the stopper further comprises:
a base portion received in the central opening and neck of the deck; and
an opening through which debris is capable of being received into the vacuum hose.

8. The vacuum cleaning apparatus of claim 7 in which the opening is an annular opening in the base of the stopper.

9. The vacuum cleaning apparatus of claim 7 in which the opening is at least one hole in the base of the stopper.

10. The vacuum cleaning apparatus of claim 7 in which the stopper is integrally formed with the deck and neck of the vacuum attachment.

11. A vacuum attachment attached to a distal end of a vacuum hose of a vacuum cleaning apparatus, comprising:
a deck that extends outward from a central opening, the deck having a top surface, a bottom surface, and a neck extending from the top surface about the central opening, the distal end of the vacuum hose being attached to the neck, and the bottom surface engaging with a work piece from which debris is to be removed; and
a stopper disposed in the central opening and neck of the deck.

12. The vacuum attachment of claim 11 wherein the deck further comprises:
a plurality of spacing elements extending from the bottom surface of the deck.

13. The vacuum attachment of claim 12 wherein the plurality of spacing elements are radially aligned along a plurality of radii extending along the bottom surface from the central opening of the deck to an outer edge of the deck.

14. The vacuum attachment of claim 11 wherein the deck is comprised of a flexible material.

15. The vacuum attachment of claim 11 wherein the stopper further comprises:
a base portion received in the central opening of the deck; and
an opening through which debris is capable of being received into the vacuum hose.

16. The vacuum attachment of claim 15 in which the opening is an annular opening in the base of the stopper.

17. The vacuum cleaning apparatus of claim 15 in which the opening is at least one hole in the base of the stopper.

18. The vacuum cleaning apparatus of claim 15 in which the stopper is integrally formed with the deck and neck of the vacuum attachment.

19. A vacuum attachment attached to a distal end of a vacuum hose of a vacuum cleaning apparatus, comprising:
a deck that extends outward from a central opening, the deck having a top surface, a bottom surface, and a neck extending from the top surface about the central opening, the distal end of the vacuum hose being attached to the neck, and the bottom surface engaging with a work piece from which debris is to be removed;
a plurality of spacing elements extending from the bottom surface of the deck; and
a stopper disposed in the central opening and neck of the deck, comprising:
a base portion received in the central opening of the deck; and
an opening through which debris is capable of being received into the vacuum hose.

20. The vacuum attachment of claim 19 in which the stopper is integrally formed with the deck and neck.
